(19) United States
(12) Patent Application Publication
(10) Pub. No.: US 2026/0279775 A1
(43) Pub. Date: Sep. 17, 2026

(54) ELECTRODE, ELECTRODE ASSEMBLY INCLUDING THE ELECTRODE, AND METHOD OF MANUFACTURING ELECTRODE

(71) Applicant: SAMSUNG SDI CO., LTD., Yongin-si (KR)

(72) Inventor: Misun LEE, Yongin-si (KR)

(21) Appl. No.: 19/439,640

(22) Filed: Jan. 5, 2026

(30) Foreign Application Priority Data
Feb. 10, 2025 (KR) 10-2025-0016781

(51) Int. Cl. H01M 4/36; H01M 4/02; H01M 4/04; H01M 4/38; H01M 4/505; H01M 4/525; H01M 4/587; H01M 50/586

(52) U.S. Cl. CPC H01M 4/366; H01M 4/0404; H01M 4/0407; H01M 4/386; H01M 4/505; H01M 4/525; H01M 4/587; H01M 50/586; H01M 2004/021

(57) ABSTRACT

An electrode includes a substrate. A first active material layer is disposed on at least one surface of the substrate and includes a first inclined portion. A second active material layer is disposed on the first inclined portion.

### CROSS-REFERENCE TO RELATED APPLICATION

This application claims priority under 35 U.S.C. § 119 to Korean Patent Application No. 10-2025-0016781, filed in the Korean Intellectual Property Office on Feb. 10, 2025, the entire contents of which are hereby incorporated by reference.

### BACKGROUND

### Field

The present disclosure relates to an electrode, an electrode assembly including the electrode, and a method of manufacturing an electrode.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

An electrode assembly is formed by winding or stacking positive electrodes, negative electrodes, and separators. Electrodes include an active material layer coated on at least one surface of a substrate, and the thickness of the active material layer varies depending on the manufacturing process conditions. In some cases, the thickness of the active material layer gradually decreases at both ends of the coated electrode. When the active material layer has an irregular thickness, the adhesion may be reduced in a portion of the electrode assembly. As a result, a resistance may increase in the electrode assembly, which causes a reduction in lifespan of a secondary battery that includes the electrode assembly.

The above information disclosed in this Background section is for enhancement of understanding of the background of the present disclosure, and therefore, it may contain information that does not constitute related (or prior) art.

### SUMMARY

The present disclosure provides an electrode, an electrode assembly including the electrode, and a method of manufacturing an electrode for solving the problems described above.

These and other aspects and features of the present disclosure will be described in or will be apparent from the following description of embodiments of the present disclosure.

According to embodiments of the present disclosure, there is provided an electrode including a substrate, a first active material layer disposed on at least one surface of the substrate and including an inclined portion, and a second active material layer disposed on the inclined portion.

A sum of a thickness of the inclined portion and a thickness of the second active material layer may be equal to or less than a maximum thickness of the first active material layer.

The second active material layer may include a second inclined portion, wherein the electrode further includes an insulating layer covering at least part of a surface of the second inclined portion and at least part of a surface of the substrate.

A width of the second active material layer may be 1 mm to 13 mm.

A material of the insulating layer may include at least one of polyimide and a ceramic.

A sum of a thickness of an overlapping portion between the second inclined portion and the first inclined portion, a thickness of the second inclined portion, and a thickness of an overlapping portion between the insulating layer and the surface of the second inclined portion may be equal to or less than a maximum thickness of the first active material layer.

A width of the insulating layer may be 0.5 mm to 8 mm.

A material of the first active material layer may include at least one of lithium cobalt oxide (LCO), lithium manganese oxide, nickel cobalt aluminum (NCA), nickel cobalt manganese (NCM), carbon (C), and silicon (Si).

A material of the second active material layer may include at least one of nickel cobalt manganese (NCM), nickel cobalt aluminum, nickel cobalt oxide (LCO), lithium iron phosphate (LFP), carbon (C), and silicon (Si).

According to embodiments of the present disclosure, there is provided an electrode assembly, including a first electrode including a first electrode tab, a second electrode including a second electrode tab, and a separator disposed between the first electrode and the second electrode, wherein at least one of the first electrode and the second electrode includes a substrate, a first active material layer disposed on at least one surface of the substrate and including an inclined portion, and a second active material layer disposed on the inclined portion.

A sum of a thickness of the inclined portion and a thickness of the second active material layer may be equal to or less than a maximum thickness of the first active material layer.

The second active material layer may include a second inclined portion, wherein at least one of the first electrode and the second electrode further includes an insulating layer covering at least part of a surface of the second inclined portion, and at least part of a surface of the substrate.

A width of the second active material layer may be 1 mm to 13 mm.

A material of the insulating layer may include at least one of polyimide and a ceramic.

A sum of a thickness of an overlapping portion between the second inclined portion and the first inclined portion, a thickness of the second inclined portion, and a thickness of an overlapping portion between the insulating layer and the surface of the second inclined portion may be equal to or less than a maximum thickness of the first active material layer.

A width of the insulating layer may be 0.5 mm to 8 mm.

A material of the first active material layer may include at least one of lithium cobalt oxide (LCO), lithium manganese oxide, nickel cobalt aluminum (NCA), nickel cobalt manganese (NCM), carbon (C), and silicon (Si).

A material of the second active material layer may include at least one of nickel cobalt manganese (NCM), nickel cobalt aluminum (NCA), nickel cobalt oxide (LCO), lithium iron phosphate (LFP), carbon (C), and silicon (Si).

According to embodiments of the present disclosure, there is provided a method for manufacturing an electrode, the method including coating a first active material layer on a substrate, drying the substrate coated with the first active material layer, coating a second active material layer on a first inclined portion formed on the first active material layer, drying the substrate coated with the first active material layer and the second active material layer, and coating an insulating layer on at least part of a second inclined portion formed on the second active material layer and at least part of a surface of the substrate.

The coating of the second active material layer on the first inclined portion formed on the first active material layer may include coating the second active material layer in a direction opposite to a direction of coating the first active material layer.

According to some embodiments of the present disclosure, an electrode, an electrode assembly including the electrode, and a method for manufacturing an electrode are provided. In the embodiments, a constant thickness of an active material layer coated on a substrate of an electrode or an insulating layer corresponding thereto is maintained to make a secondary battery including the electrode more stable.

In the embodiments, positive electrodes, separators, negative electrodes are sequentially stacked in close contact to improve the stability of a secondary battery including the electrode assembly.

The structural stability of a secondary battery may be improved to prevent an increase in resistance and suppress side reactions, thereby improving the lifespan of a secondary battery including an electrode assembly according to embodiments of the present disclosure.

According to some embodiments of the present disclosure, with an insulating layer disposed on an electrode tab, short-circuits between positive electrodes and negative electrodes may be reduced due to secondary battery deformation or separator shrinkage in high-temperature conditions, etc., thereby enhancing the stability and reliability of the secondary battery.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view of a secondary battery according to embodiments of the present disclosure;

FIG. 2 is a perspective view of an electrode assembly according to embodiments of the present disclosure;

FIG. 3 is a view of cross-sections of a top of an electrode assembly taken along lines A-A and B-B in FIG. 2 according to an embodiment of the present disclosure;

FIG. 4 is a view of cross-sections of a top of an electrode assembly taken along lines A-A and B-B in FIG. 2 according to another embodiment of the present disclosure;

FIG. 5 is a side cross-sectional view of a substrate where a first active material layer is coated according to embodiments of the present disclosure;

FIG. 6 is a plan view of a substrate where a first active material layer is coated according to embodiments of the present disclosure;

FIG. 7 is a side cross-sectional view of a substrate where a first active material layer and a second active material layer are coated according to embodiments of the present disclosure;

FIG. 8 is a plan view of a substrate where a first active material layer and a second active material layer are coated according to embodiments of the present disclosure;

FIG. 9 is a side cross-sectional view of a substrate where a first active material layer, a second active material layer, and an insulating layer are coated according to embodiments of the present disclosure;

FIG. 10 is a plan view of a substate where a first active material layer, a second active material layer, and an insulating layer are coated according to embodiments of the present disclosure; and

FIG. 11 is a flowchart of an electrode manufacturing method according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

Also, it will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, in the figures, dimensions of the various elements, layers, etc. may be exaggerated for clarity of illustration. The same reference numerals designate the same elements.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, etc. may be used herein to describe various elements, these elements should not be limited by these terms. These terms are only used to distinguish one element from another element. Thus, a first element could be termed a second element unless the context clearly indicates otherwise.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”. It will also be understood that when an element is referred to as being “electrically coupled” to another element, it may be directly coupled to the other element or intervening elements may be present.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

According to embodiments of the present disclosure, the sizes of layers and areas illustrated in the drawings may be exaggerated for clarity of explanation. The sizes in the drawings are only for ease of explanation, but the present disclosure is not limited thereto. Like reference numerals in the drawings denote like elements throughout the specification.

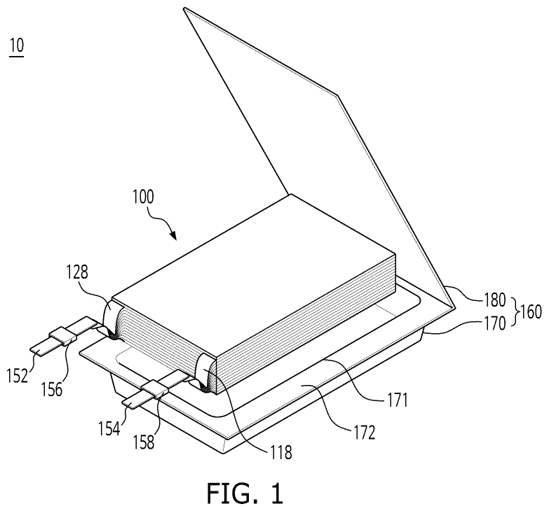

FIG. 1 is a perspective view of a secondary battery according to embodiments of the present disclosure.

A secondary battery 10 according to embodiments of the present disclosure may include an electrode assembly 100 and a case 160 in which the electrode assembly 100 is accommodated.

The electrode assembly 100 may have a structure where positive electrodes and negative electrodes in the form of sheets are alternately stacked with separators interposed therebetween. A first electrode may be a positive electrode, and a second electrode may be a negative electrode, or a first electrode may be a negative electrode, and a second electrode may be a positive electrode.

In the electrode assembly 100, a first electrode tab 118 may be formed at a side of the first electrode, and a second electrode tab 128 may be formed at a side of the second electrode. The first electrode tab 118 and the second electrode tab 128 may be formed by welding tabs to non-coated portions of the first electrode and the second electrode, or the tabs 118 and 128 may be formed by stamping the non-coated portions of the first electrode and the second electrode. When the first electrode and the second electrode are stacked, the first electrode tab 118 and the second electrode tab 128 may be aligned parallel to each other with a predetermined spacing therebetween. When the first electrode is a positive electrode, the first electrode tab 118 may be a positive electrode tab, and the second electrode tab 128 may be a negative electrode tab. When the first electrode and the second electrode are opposite polarities, the first electrode tab 118 may be a negative electrode tab, and the second electrode tab 128 may be a positive electrode tab.

The first electrode tab 118 and the second electrode tab 128 may be respectively coupled to a first electrode terminal 152 and a second electrode terminal 154, and through the tabs 118 and 128 the first electrode assembly 100 may be electrically connected to outside of the secondary battery 10. Parts of the first and second electrode terminals 152 and 154 may be exposed to the outside of the case 160. The first electrode tab 118 and the second electrode 128 will be referred to herein as the electrode tabs 118 and 128, and the first electrode terminal 152 and the second electrode terminal 154 will be referred to herein as the electrode terminals 152 and 154 when needed for clarification. The electrode tabs 118 and 128 and the electrode terminals 152 and 154 may be formed of metal, such as aluminum, copper, or nickel, and may be formed of a metal with a predetermined level of electrical conductivity to minimize voltage drop.

The electrode terminals 152 and 154 may include terminal insulating films 156 and 158 disposed on bottom surfaces, top surfaces, or both top and bottom surfaces. In addition, the electrode terminals 152 and 154 may include the terminal insulating films 156 and 158 attached to portions in contact with sealing areas at the edges of the case 160.

The case 160 may form the exterior of the secondary battery 10 and may include, for example, a polymer film made of a material such as polypropylene and a metal foil made of a material such as aluminum. According to another example, the case 160 may be formed of a conductive metal such as aluminum, stainless steel (SUS), aluminum alloy, or nickel-plated steel. The case 160 may provide a space in which the electrode assembly 100 is accommodated. The case 160 may be a pouch-type case, and the secondary battery 10 may be a pouch-type secondary battery. However, the scope of the present disclosure is not limited with respect to the type of secondary battery, but the secondary battery 10 may be a battery cell of any form such as prismatic or cylindrical.

The case 160 may include an upper case 180 and a lower case 170, which may be formed by folding the middle of a rectangular case film with respect to the length direction of the film. A receiving portion 171 for accommodating the electrode assembly 100 may be formed in the approximate central area of the lower case 170 by press processing, etc. In addition, an extension portion 172 may be formed outward in four directions from the upper edge of the receiving portion 171.

The lower case 170 may be coupled to the open end of the upper case 180 to seal the upper case 180. One side of the lower case 170 may be open, and the upper case 180 may seal the open side of the lower case 170.

The case 160 may include an electrolyte injection hole (not shown) that extends through the case 160. After the upper case 180 is coupled to and sealed to the lower case 170, the electrolyte injection hole may be formed to allow an electrolyte to be injected into the case 160. The electrolyte injection hole may be sealed by a sealing member after the electrolyte is injected.

The secondary battery 10 may be a lithium battery cell (e.g., a lithium-ion battery cell), a sodium battery cell, etc. However, the scope of the present disclosure is not limited in this regard, and the secondary battery 10 may be any form of battery capable of repeatedly providing electricity through charging and discharging. According to embodiments, when the secondary battery 10 is a lithium battery cell, the secondary battery 10 may be used in electric vehicles (EVs) or hybrid vehicles such as plug-in hybrid electric vehicles (PHEVs) due to its excellent life characteristics and high-rate characteristics. In other embodiments, lithium battery cells according to embodiments of the present disclosure may be used in fields that require a large amount of power storage, such as electric bicycles, power tools, etc.

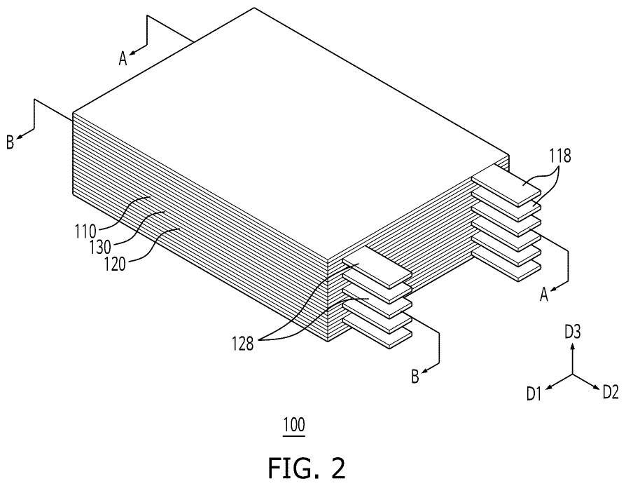

FIG. 2 is a perspective view of an electrode assembly according to embodiments of the present disclosure.

The electrode assembly 100 may include a first electrode 110, a second electrode 120, and a separator 130 disposed between the first electrode 110 and the second electrode 120. The first electrode 110, the second electrode 120, and the separator 130 each may be formed of a thin-plate shape or a film-shape. The electrode assembly 100 may include a structure where the first electrode 110 and the second electrode 120 are alternately stacked sheets with the separator 130 interposed between the sheets.

In addition, the electrode assembly may be a Z-stack electrode assembly in which a positive electrode plate and a negative electrode plate are inserted into both sides of a separator, which is then bent into a Z-stack.

The first electrode 110 and the second electrode 120 are illustrated as being of the same size in FIG. 2. But in other embodiments, the first and second electrodes 110 and 120 may be different sizes such that an overhang may occur. For example, the area of a negative electrode plate may be greater than that of a positive electrode plate.

FIG. 2 is a view of a stacked electrode assembly 100. In embodiments of the present disclosure, the number, size, and structure of electrodes are not limited. The outermost of the electrode assembly 100 may be the first electrode 110 or the second electrode 120. The first electrode 110 may be a positive electrode, and the second electrode 120 may be formed of a negative electrode.

Adversely, the first electrode 110 may be a negative electrode, and the second electrode 120 may be a positive electrode.

When the first electrode 110 is a positive electrode, a positive electrode active material layer, primarily composed of a lithium-based oxide, may be coated on both sides of a positive electrode substrate formed of a thin film aluminum foil. A positive electrode non-coated portion where the positive electrode active material layer is not provided may be formed at both ends of the positive electrode substrate.

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

For example, the positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause a chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but is not limited thereto.

The positive electrode active material may include a compound (lithiated intercalation compound) that is capable of intercalating and deintercalating lithium. Specifically, at least one of a composite oxide of lithium and a metal selected from cobalt, manganese, nickel, or combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The second electrode 120 may be a negative electrode, which may include a negative electrode substrate of thin film copper foil and a carbon-based negative electrode active material layer coated on both sides of the negative electrode substrate. A negative electrode non-coated portion where a negative electrode active material layer is not provided may be formed at both ends of a negative electrode substrate.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

As the negative electrode current collector, one selected from copper foil, nickel foil, stainless steel foil, titanium foil, nickel foam, copper foam, conductive metal-coated polymer substrate, and combinations thereof may be used.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, STiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

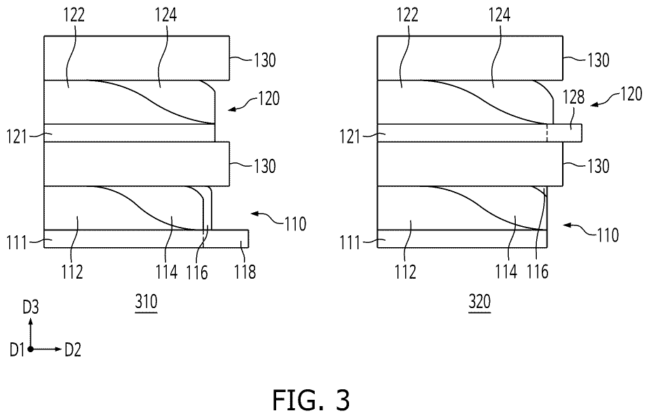

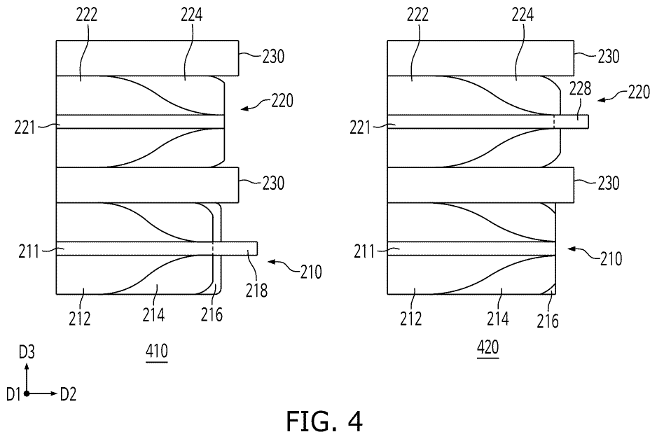

According to embodiments, at least one of the first electrode 110 and the second electrode 120 may include a substrate, a first active material layer disposed on at least one surface of the substrate and including a first inclined portion, and a second active material layer disposed on the first inclined portion. The second active material layer may include a second inclined portion, and the electrode assembly 100 may further include an insulating layer covering at least part of the surface of the second inclined portion and at least part of the surface of the substrate. A detailed description of such a configuration will be made with respect to FIG. 3 and FIG. 4.

The first electrode tab 118 may be formed at a side of the first electrode 110, and the second electrode tab 128 may be formed at a side of the second electrode 120. The first electrode tab 118 and the second electrode tab 128 may be welded to the non-coated portions of the first electrode 110 and the second electrode 120, or the tabs 118 and 128 may be formed by stamping the non-coated portions of the first electrode 110 and the second electrode 120. In a stacked state, the first electrode tab 118 and the second electrode tab 128 may be positioned at the same side of the electrode assembly 100. According to another example, in a stacked state, the first electrode tab 118 and the second electrode tab 128 may be positioned at different sides of the electrode assembly 100.

When the first electrode 110 is a positive electrode, the first electrode tab 118 maya positive electrode tab and the second electrode tab 128 may be a negative electrode tab. When the first electrode 110 and the second electrode 120 are different polarities, the first electrode tab 118 may be a negative electrode tab, and the second electrode tab 128 may be a positive electrode tab.

FIG. 3 is an exemplary view of cross-sections of the top of an electrode assembly taken along lines A-A and B-B in FIG. 2 according to embodiments of the present disclosure. FIG. 3 is an exemplary view of a cross-section 310 taken along line A-A of FIG. 2, and a cross-section 320 taken along line B-B of FIG. 2 viewed from direction D1 of a coordinate system.

Referring to FIG. 3, the electrode assembly 100 may include the first electrode 110, the second electrode 120, and the separator 130. The first electrode 110 may include the first electrode tab 118 formed at a side, and the second electrode 120 may include the second electrode tab 128 formed the side. In a stacked state, the first electrode tab 118, and the second electrode tab 128 may be formed at the same side of the electrode assembly 100. The first electrode 110 may be a positive electrode, and the second electrode 120 may be a negative electrode. Accordingly, the first electrode tab 118 may be a positive electrode tab, and the second electrode tab 128 may be a negative electrode tab.

Each of the first electrode 110 and the second electrode 120 may include first active material layers 112 and 122 and second active material layers 114 and 124 disposed on substrates 111 and 121. The active materials may include a positive electrode active material and/or a negative electrode active material. For example, the first active material layers 112 and 122 may include a first positive electrode active material layer 112 and a first negative electrode active material layer 122, and the second active material layers 114 and 124 may include a second positive electrode active material layer 114 and a second negative electrode active material layer 124.

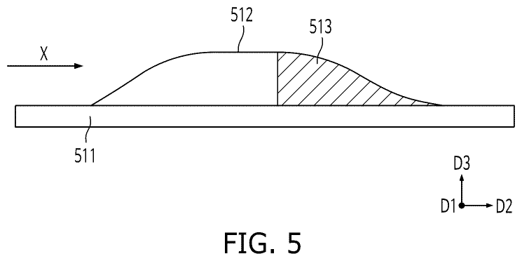

The first electrode 110 may include a first substrate 111, a first positive electrode active material layer 112, a second positive electrode active material layer 114, and an insulating layer 116. As shown in FIG. 5, the first positive electrode active material layer 112 may be disposed on a surface of the first substrate 111 and may include a first inclined portion 513. The second positive electrode active material layer 114 may be disposed on the first inclined portion 513 of the first positive electrode active material layer 112.

The first positive electrode active material layer 112 and the second positive electrode active material layer 114 may be coated different positive electrode active materials that are chosen based on desired operating voltages. In some embodiments, the operating voltage of the first positive electrode active material layer 112 may be greater than the operating voltage of the second positive electrode active material layer 114. For example, when the first positive electrode active material layer 112 is lithium cobalt oxide (LCO), the second positive electrode active material layer 114 may include at least one of nickel cobalt manganese (NCM), nickel cobalt aluminum (NCA), and lithium iron phosphate (LFP). In another example, when the first positive electrode active material layer 112 is lithium manganese oxide (LMO), the second positive electrode active material layer 114 may include at least one of nickel cobalt oxide (NCO), nickel cobalt manganese (NCM), nickel cobalt aluminum (NCA), and lithium iron phosphate (LFP). In another example, when the first positive electrode active material layer 112 is nickel cobalt aluminum (NCA) or nickel cobalt manganese (NCM), the second positive electrode active material layer 114 may include lithium iron phosphate (LFP). With such configurations, the safety of the first electrode 110 may be improved.

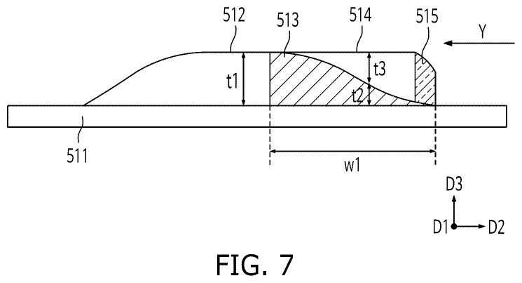

Referring to FIGS. 3 and 7, the insulating layer 116 may be disposed to cover at least part of the surface of a second inclined portion 515 of the second positive electrode active material layer 114 and at least part of the surface of the substrate 111. As shown in the cross-section 310, the insulating layer 116 may be disposed to cover at least part of the surface of the second inclined portion 515 and at least part of the first electrode tab 118.

The insulating layer 116 may include an insulating material such as at least one of polyimide (PI) or a ceramic. The polyimide (PI) may be based on a polymer substance, and the ceramic may be a material based on a non-metallic substance. Both of these materials may provide high chemical stability, thereby protecting the surface of the substrate 111. Both of these materials may also have excellent electrical insulation properties that prevent short circuits. However, the material of the insulating layer 116 is not limited to to polyimide and a ceramic.

Due to the characteristics of the insulating material, when a secondary battery is deformed or when electrodes are cut during the manufacturing process forming sharp edges of the electrodes, internal short-circuits that may otherwise occur in the stacked first electrode 110 and the second electrode 120 may be prevented. Further, if the separator 130 contracts, such as in high-temperature conditions, a short-circuit between the positive first electrode 110 and the negative second electrode 120 may be prevented. Accordingly, the safety and reliability of the performance of the secondary battery may be enhanced.

The second electrode 120 may include a second substrate 121, a first negative electrode active material layer 122, and a second negative electrode active material layer 124. As shown in FIGS. 3 and 5, the first negative electrode active material layer 122 may be disposed on one surface of the second substrate 121, and the first negative active material layer 122 may include the first inclined portion 513. The second negative electrode active material layer 124 may be disposed on the first inclined portion 513 of the first negative electrode active material layer 122.

In embodiments, the first negative electrode active material layer 122 and the second negative electrode active material layer 124 may be the same or different negative electrode active materials. For example, when the first negative electrode active material layer 122 is made of one of carbon (C), silicon (Si), or a mixture thereof, the second negative electrode active material layer 124 may include at least one of carbon (C) and silicon (Si).

The sum of the thickness of the first inclined portion of the first positive electrode active material layer 112 and the thickness of the second positive electrode active material layer 114 may be equal to or less than the maximum thickness of the first positive electrode active material layer 112. Further, the sum of the thickness where a second inclined portion of the second positive electrode active material layer 114 and the first inclined portion of the first positive electrode active material layer 112 overlap, the thickness of the second inclined portion, and the thickness of where the insulating layer 116 and the surface of the second inclined portion overlap may be equal to or less than the maximum thickness of the first positive electrode active material layer 112. Further descriptions in this regard will be made in detail below with reference to FIG. 5 to FIG. 10.

According to embodiments of the present disclosure, the sum of the thickness of the first inclined portion of the first negative electrode active material layer 122 and the thickness of the second negative electrode active material layer 124 may be equal to or less than the maximum thickness of the first negative electrode active material layer 122. With such a configuration, when the first electrode 110, the separator 130, and the second electrode 120 are stacked, the first electrode 110, the second electrode 120, and the separator 130 may be in close contact with one another to thereby improve the structural stability of the electrode assembly. Thus, an increase in resistance may be prevented s and side reactions may be reduced, which thereby prevent reduction in lifespan of a secondary battery including the electrode assembly.

FIG. 4 illustrates cross-sections of the top of an electrode assembly taken along lines A-A and B-B in FIG. 2 according to another embodiment of the present disclosure. In particular, FIG. 4 illustrates an example of a cross-section 410 taken along line A-A in FIG. 2 and a cross-section 420 taken along line B-B in FIG. 2 viewed from direction D1 of the depicted coordinate system.

Referring to FIG. 4, a first electrode 210 may include a first substrate 211, a first positive electrode active material layer 212, a second positive electrode active material layer 214, and an insulating layer 216. The first positive electrode active material layer 212 may be disposed on both sides of the first substrate 211, and the first positive electrode active material layer 212 may include the first inclined portion 513 as shown in FIG. 5. The second positive electrode active material layer 214 may be disposed on the first inclined portion 513 of the first positive electrode active material layer 212. A second electrode 220 may include a second substrate 221, a first negative electrode active material layer 222, and a second negative electrode active material layer 224. The first negative electrode active material layer 222 may be disposed on both sides of the second substrate 221, and the first negative electrode active material layer 222 may include the first inclined portion 513 as shown in FIG. 5. The second negative electrode active material layer 224 may be disposed on the first inclined portion 513 of the first negative electrode active material layer 222.

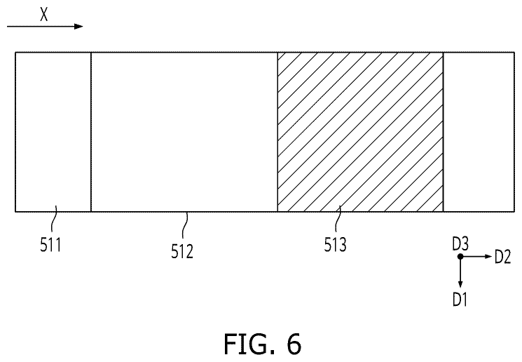

FIG. 3 is a side cross-sectional view of a substrate coated with a first active material layer, and FIG. 6 is a plan view illustrating an example where a substrate is coated with a first active material layer. here, the first positive electrode active material layer and the first negative electrode active material layer will be referred to as a first active material layer 512, and the second positive electrode active material layer and the second negative electrode active material layer will be referred to as a second active material layer 514.

Referring to FIGS. 5 and 6, a first active material layer 512 may be disposed on at least one surface of a substrate 511 and may include a first inclined portion 513. The first inclined portion 513 may be formed at at least one end of the first active material layer 512. The first active material layer 512 may be coated on a surface of the substrate 511 in the length direction (X-direction) of the substrate 511. As such, the first inclined portion 513 may be formed at an X-direction end of the first active material layer 512.

The thickness of the first inclined portion 513 may gradually decrease in the direction toward where the surface of the substrate 511 is exposed. That is, the length of the first inclined portion 513 in the direction D3 may gradually decrease toward the direction where the surface of the substrate 511 is exposed. In such a configuration, when a first electrode, a separator, and a second electrode are stacked, the first inclined portion 513 and the separator may not be in close contact such that resistance in a secondary battery including the electrode assembly may increase, and structural stability of the secondary battery may decrease.

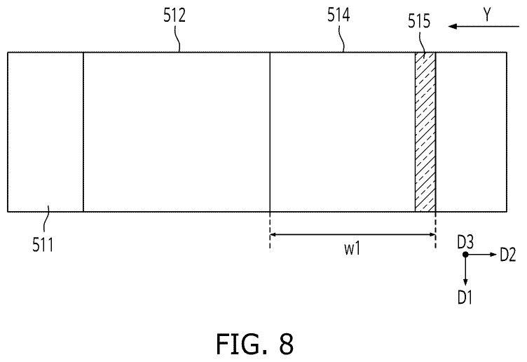

FIG. 7 is across-sectional view of a substrate coated with a first active material layer and a second active material layer, and FIG. 8 is a plan view of a substrate coated with a first active material layer and a second active material layer

Referring to FIGS. 7 and 8, an electrode 500 may include a substrate 511, a first active material layer 512, and a second active material layer 514. The first active material layer 512 may be disposed on at least one surface of the substrate 511 and may include a first inclined portion 513. As shown in FIG. 5, the second active material layer 514 may be disposed on the first inclined portion 513. The second active material layer 514 may be coated in a direction (Y direction) opposite to the direction in which the first active material layer 512 is coated (X direction).

The material of the first active material layer 512 may include at least one of lithium cobalt oxide (LCO), lithium manganese oxide (LMO), nickel cobalt aluminum (NCA), nickel cobalt manganese (NCM), carbon (C), and silicon (Si). The material of the second active material layer 514 may include at least one of nickel cobalt manganese (NCM), nickel cobalt aluminum (NCA), nickel cobalt oxide (LCO), lithium iron phosphate (LFP), carbon (C), and silicon (Si).

The sum of a thickness t2 of the first inclined portion 513 and a thickness t3 of the second active material layer 514 may be equal to or less than a maximum thickness t1 of the first active material layer 512. Specifically, in the D3 direction as depicted, the sum of a length t2 of the first inclined portion 513 and a length t3 of the second active material layer 514 may be equal to or less than the maximum length t1 of the first active material layer 512. As such, when the first electrode, the separator, and the second electrode are stacked, the first electrode, the second electrode, and the separator may be in close contact. Such a configuration improves structural stability. And, as a result, an increase in resistance may be prevented and side reactions may be suppressed, thereby maintaining lifespan of a secondary battery including the electrode assembly.

A width w1 of the second active material layer 514 may be equal to the width of the first inclined portion 513 of the first active material layer 512. In some examples, the width w1 of the second active material layer 514 may be 1 mm to 13 mm. Specifically, the length w1 of the second active material layer 514 with respect to Y direction may be 1 mm to 13 mm. Thus, the second active material layer 514 may completely cover the first inclined portion 513 and closely contact the separator. However, the thickness and the width of each of the first active material layer 512 and the second active material layer 514 are not limited to these examples may vary in other examples of the present disclosure.

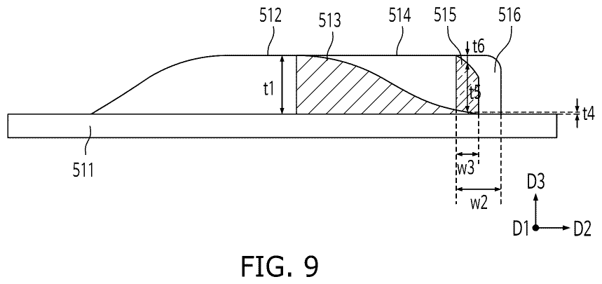

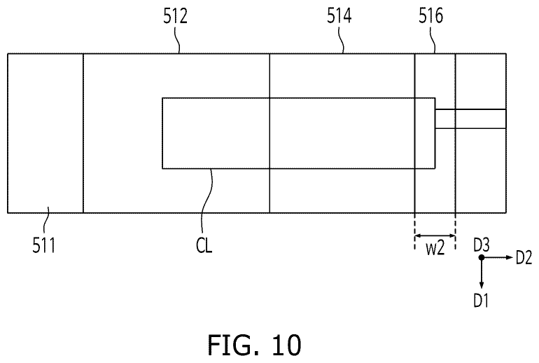

FIG. 9 is a cross-sectional view of a substrate coated with a first active material layer, a second active material layer, and an insulating layer according, and FIG. 10 is a plan view of a substrate coated with a first active material layer, a second active material layer, and an insulating layer.

Referring to FIGS. 9 and 10, in embodiments of the present disclosure an electrode 500 may include a substrate 511, a first active material layer 512, a second active material layer 514, and an insulating layer 516. The insulating layer 516 may be arranged to cover at least a part of the surface of a second inclined portion 515 of the second active material layer 514 and at least a part of the surface of the substrate 511.

A thickness t4 of an overlapping portion between the first inclined section 513 and the second inclined section 515, a thickness t5 of the second inclined portion 515, and a thickness t6 of an overlapping portion between the insulating layer 516 and the surface of the second inclined portion 515 may be equal to or less than a maximum thickness t1 of the first active material layer 512. With respect to D3 direction, the sum of a length t4 an overlapping portion between the first inclined portion 513 and the second inclined portion 515, a length t5 of the second inclined portion 515, and a length t6 of an overlapping portion between the insulating layer 516 and the surface of the second inclined portion 515 may be equal to or less than the maximum length t1 of the first active material layer 512.

In some embodiments, a width w2 of the insulating layer 516 may be 0.5 mm to 8 mm. That is, with respect to D2 direction, a length w2 of the insulating layer 516 may be 0.5 mm to 8 mm. In some embodiments, a width w3 of an overlapping portion between the insulating layer 516 and the surface of the second inclined portion 515 may be 0.5 mm to 5 mm. That is, with respect to D2 direction, a width w3 of an overlapping portion between the insulating layer 516 and the surface of the second inclined portion 515 may be 0.5 mm to 5 mm.

As shown in FIG. 10, the electrode 500 may be stamped along a cutting line CL For example, the tab portion of the cutting line CL may include the first active material layer 512, the second active material layer 514, and the insulating layer 516. In other embodiments, the tab portion of the cutting line CL may include only the insulating layer 516.

The thicknesses and the widths of the first active material layer 512, the second active material layer 514, and the insulating layer 516 are not limited to the embodiments described above. Rather, the thicknesses and widths may vary in different embodiments of the present disclosure.

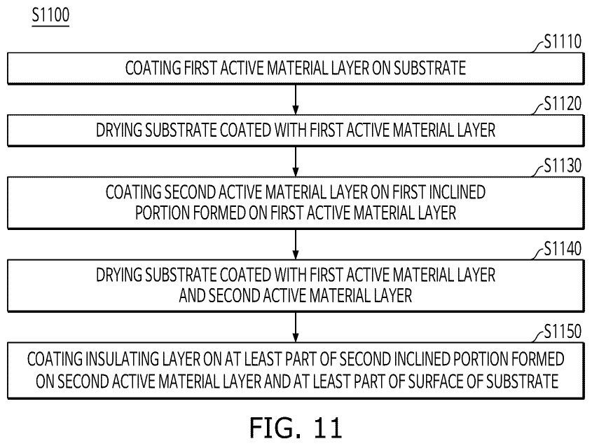

FIG. 11 is a flowchart of a method of manufacturing an electrode according to embodiments of the present disclosure.

Referring to FIG. 11, a method for manufacturing an electrode in step S1100 may be initiated by coating a first active material layer on a substrate in step S1110. Then, a step of drying a substrate coated with a first active material layer may be performed in step S1120. And a step of coating a second active material layer on a first inclined portion formed on a first active material layer may be performed in step S1130.

According to embodiments, the step of coating the second active material layer on the first inclined portion formed on the first active material layer in step S1130 may include coating the second active material layer in a direction opposite to the direction of coating the first active material layer. The first active material layer may include a first positive electrode active material layer and a first negative electrode active material layer, and the second active material layer may include a second positive electrode active material layer and a second negative electrode active material layer. The first positive electrode active material layer and the second negative electrode active material layer may be coated with different positive electrode active materials based on a desired operating voltage. The operating voltage of the first positive electrode active material layer may be greater than the operating voltage of the second positive electrode active material layer. For example, when the first positive electrode active material layer is lithium cobalt oxide (LCO), the second positive electrode active material layer may include at least one of nickel cobalt manganese (NCM), nickel cobalt aluminum (NCA), and lithium iron phosphate (LFP). When the first positive electrode active material layer is lithium manganese oxide (LMO), the second positive electrode active material layer may include nickel cobalt oxide (NCO), nickel cobalt manganese (NCM), nickel cobalt aluminum (NCA), and lithium iron phosphate (LFP). When the first positive electrode active material layer is nickel cobalt aluminum (NCA) or nickel cobalt manganese (NCM), the second positive electrode active material layer may include lithium iron phosphate (LFP). With such a configuration, the safety of the first electrode may be enhanced. In some embodiments, the first negative electrode active material layer and the second negative electrode active material layer may be coated with the same or different negative electrode active materials. For example, when the first positive electrode active material layer is carbon (C), silicon (Si), or a mixture of carbon and silicon, the second negative electrode active material layer 124 may include at least one of carbon (C) and silicon (Si).

The step of drying a substrate coated with a first active material layer and a second active material layer may be performed in step S1140. The step of coating an insulating layer on at least part of a second inclined portion formed on a second active material layer and at least part of a surface of a substrate may be performed in step S1150.

According to embodiments, the insulating layer may include an insulating material. The material of the insulating layer may include at least one of polyimide (PI) or a ceramic. Polyimide may be a material based on polymeric substances, and the ceramic may be a material based on non-metallic substances. Both polyimide and a ceramic provide high chemical stability to protect substrate surfaces and excellent electrical insulation to prevent short circuits. However, the material of the insulating layer is not limited to these examples.

The flow chart of FIG. 11 and the above description is merely exemplary, and the scope of the present disclosure is not limited to the flow chart of FIG. 11 and the above description. For example, one or more steps in the flow chart and the above description may be added/changed/deleted, the orders of one or more steps may be changed, and one or more steps may be performed simultaneously.

Although the present disclosure has been described above with respect to embodiments thereof, the present disclosure is not limited thereto. Various modifications and variations can be made thereto by those skilled in the art within the spirit of the present disclosure.

What is claimed is:

1. An electrode comprising:
a substrate;
a first active material layer disposed on at least one surface of the substrate and including an inclined portion; and
a second active material layer disposed on the inclined portion.

2. The electrode as claimed in claim 1, wherein a sum of a thickness of the inclined portion and a thickness of the second active material layer is equal to or less than a maximum thickness of the first active material layer.

3. The electrode as claimed in claim 1, wherein the inclined portion is a first inclined portion,
wherein the second active material layer comprises a second inclined portion, and
wherein the electrode further comprises an insulating layer covering at least part of a surface of the second inclined portion and at least part of a surface of the substrate.

4. The electrode as claimed in claim 1, wherein a width of the second active material layer is 1 mm to 13 mm.

5. The electrode as claimed in claim 3, wherein insulating layer includes at least one of polyimide and a ceramic.

6. The electrode as claimed in claim 3, wherein a sum of a thickness of an overlapping portion between the second inclined portion and the first inclined portion, a thickness of the second inclined portion, and a thickness of an overlapping portion between the insulating layer and the surface of the second inclined portion is equal to or less than a maximum thickness of the first active material layer.

7. The electrode as claimed in claim 3, wherein a width of the insulating layer is 0.5 mm to 8 mm.

8. The electrode as claimed in claim 1, wherein the first active material layer includes at least one of lithium cobalt oxide, lithium manganese oxide, nickel cobalt aluminum, nickel cobalt manganese, carbon, and silicon.

9. The electrode as claimed in claim 1, wherein the second active material layer includes at least one of nickel cobalt manganese, nickel cobalt aluminum, nickel cobalt oxide, lithium iron phosphate, carbon, and silicon.

10. An electrode assembly comprising:
a first electrode including a first electrode tab;
a second electrode including a second electrode tab; and
a separator disposed between the first electrode and the second electrode,
wherein at least one of the first electrode and the second electrode comprises:
a substrate,
a first active material layer disposed on at least one surface of the substrate and including an inclined portion, and
a second active material layer disposed on the inclined portion.

11. The electrode assembly as claimed in claim 10, wherein a sum of a thickness of the inclined portion and a thickness of the second active material layer is equal to or less than a maximum thickness of the first active material layer.

12. The electrode assembly as claimed in 10, wherein the inclined portion is a first inclined portion,
wherein the second active material layer comprises a second inclined portion, and
wherein at least one of the first electrode and the second electrode further comprises an insulating layer covering at least part of a surface of the second inclined portion and at least part of a surface of the substrate.

13. The electrode assembly as claimed in claim 10, wherein a width of the second active material layer is 1 mm to 13 mm.

14. The electrode assembly as claimed in claim 12, wherein the insulating layer includes at least one of polyimide and a ceramic.

15. The electrode assembly as claimed in claim 12, wherein a sum of a thickness of an overlapping portion between the second inclined portion and the first inclined portion, a thickness of the second inclined portion, and a thickness of an overlapping portion between the insulating layer and the surface of the second inclined portion is equal to or less than a maximum thickness of the first active material layer.

16. The electrode assembly as claimed in claim 12, wherein a width of the insulating layer is 0.5 mm to 8 mm.

17. The electrode assembly as claimed in claim 10, wherein the first active material layer includes at least one of lithium cobalt oxide, lithium manganese oxide, nickel cobalt aluminum, nickel cobalt manganese, carbon, and silicon.

18. The electrode assembly as claimed in claim 10, wherein the second active material layer includes at least one of nickel cobalt manganese, nickel cobalt aluminum, nickel cobalt oxide, lithium iron phosphate, carbon, and silicon.

19. A method for manufacturing an electrode, the method comprising:
coating a first active material layer on a substrate;
drying the substrate coated with the first active material layer;
coating a second active material layer on a first inclined portion formed on the first active material layer;
drying the substrate coated with the first active material layer and the second active material layer; and
coating an insulating layer on at least part of a second inclined portion formed on the second active material layer and at least part of a surface of the substrate.

20. The method as claimed in claim 19, wherein the coating of the second active material layer on the first inclined portion formed on the first active material layer comprises coating the second active material layer in a direction opposite to a direction of coating the first active material layer.
